(19) United States
(12) Patent Application Publication
(10) Pub. No.: US 2007/0130294 A1
(43) Pub. Date: Jun. 7, 2007

(54) METHODS AND APPARATUS FOR COMMUNICATING WITH AUTONOMOUS DEVICES VIA A WIDE AREA NETWORK

(76) Inventor: Leo Nishio, San Francisco, CA (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(21) Appl. No.: 11/565,345

(22) Filed: Nov. 30, 2006

Related U.S. Application Data
(60) Provisional application No. 60/741,934, filed on Dec. 2, 2005.

(51) Int. Cl. G06F 15/16

(52) U.S. Cl. 709/219

(57) ABSTRACT

A controller for providing autonomous control of an electro-mechanical device is described. The controller includes a processing device, a memory associated with the processing device, and at least one input/output (I/O) interface associated with said processing device. The controller is configured to operate at least one electromechanical device connected thereto and to maintain proper operation of the controller and the electromechanical device by reporting activity to a server and requesting configuration updates from the server.

### CROSS REFERENCE TO RELATED APPLICATIONS

This application is entitled to the benefit of, and claims priority to, provisional U.S. Patent Application Ser. No. 60/741,934 filed Dec. 2, 2005, and entitled “Methods and Apparatus for Communicating With Autonomous Devices Via A Wide Area Network”, which is hereby incorporated by reference in its entirety.

### BACKGROUND OF THE INVENTION

This invention relates generally to networks and more particularly, to methods and apparatus for securely managing many autonomous devices in diverse network environments utilizing the existing infrastructure provided by an existing wide area network such as the Internet.

The Internet can provide virtually ubiquitous connectivity to any networked device. Still, using the Internet to communicate with remote devices has its challenges. Depending on the specific task or application, communications to and between network devices must be both secure and reliable to varying degrees. In many network environments the overriding security concerns necessitate a network architecture that separates what is inside and what is outside by erecting virtual barriers or gates for communications in the form of firewalls.

For the most part firewalls are designed to hide and protect what is inside (private information and assets) from those outside the firewall (the public and/or adversaries). As such it is relatively easy for devices inside the firewall to access public resources and other publicly accessible devices outside the firewall. For example, web browser requests easily flow out of a secure location allowing users access to the wealth of information on the Internet. It is much more difficult for those outside the firewall to communicate with or access resources and devices within the firewall unless such access is explicitly permitted. For instance, one cannot access a company's corporate employee database from outside the company's network firewall. However, a company's web site for product sales and customer support must be easily accessible by the public.

Even without a firewall, difficulties may persist. Networks may be configured such that internet protocol (IP) addresses are assigned dynamically by network routers using the Dynamic Host Configuration Protocol (“DHCP”). This protocol and other router configuration parameters make it difficult to address a particular computer or other network device from outside the sub-network defined by the router.

While it is possible to configure a network, its routers, and its firewall so that certain resources and devices are accessible from the outside of the firewall, considerable efforts are required to properly configure and maintain those capabilities without compromising overall network security and functionality. For a website used for sales to the public, this may be difficult but manageable. However, for multiple devices spread throughout an organization, maintaining both access and security is more difficult.

If such communications capabilities are mission critical, devastating outages can be inadvertently caused through seemingly trivial changes to a single network router's configuration during an upgrade or regular network maintenance. As in almost any security application, it is difficult and expensive to maintain and increase security without restricting ease of use and flexibility.

### BRIEF DESCRIPTION OF THE INVENTION

In one embodiment, a controller for providing autonomous control of an electromechanical device is provided. The controller includes a processing device, a memory associated with the processing device, and at least one input/output (I/O) interface associated with said processing device. The controller is configured to operate at least one electromechanical device connected thereto and to maintain proper operation of the controller and the electromechanical device by reporting activity to a server and requesting configuration updates from the server.

In another embodiment, a system for controlling an electro-mechanical device is provided. The system comprises at least one server, positioned outside of at least one security feature, and at least one controller, positioned inside at least one security feature and coupled to an electromechanical device. The at least one controller is configured to initiate communications with the at least one server over a network. The at least one controller comprising a processing device and a memory associated with the processing device, the controller configured to operate the electromechanical device independent of the server.

In yet another embodiment, a method of configuring a controller to provide autonomous control of an electromechanical device is provided. The method includes configuring the controller to perform at least one of a monitoring and a control application, the application comprising an electro-mechanical device. The method further includes configuring the controller to initiate communications with a server, and configuring the controller to report activity and request updated configurations from the server.

### BRIEF DESCRIPTION OF THE DRAWINGS

FIG. 1 is a schematic illustration of devices networked in accordance with an embodiment of the present invention and managed remotely over the open Internet.

FIG. 2 is a schematic illustration of devices networked in accordance with an embodiment of the present invention and managed locally through a local area network.

FIG. 3 is a schematic illustration of an exemplary network device, specifically a fingerprint reader/lock controller for use in an access control system.

FIG. 4 is a schematic illustration of an embodiment of the reader/controller of FIG. 3.

FIG. 5 is a schematic illustration of another embodiment of the reader/controller of FIG. 3.

FIG. 6 is an exemplary screen-shot of an embodiment of a web page used to configure a fingerprint reader in a physical access control application.

FIG. 7 is an exemplary screen-shot of an embodiment of a web page used to enroll a user and manage their permissions in a physical access control application.

FIG. 8 is an exemplary screen-shot of an embodiment of a web page used to create notifications for various events that are detected in a physical access control application.

FIG. 9 is an exemplary screen-shot of an embodiment of a web page used to generate reports in a physical access control application.

FIG. 10 is an exemplary screen-shot of an embodiment of a web page used to monitor activity in real time in a physical access control application.

### DETAILED DESCRIPTION OF THE INVENTION

Communications over a wide area network (WAN) (e.g., the Internet) from a server to a local area network (LAN) often have to go through some type of security, in one example, a firewall. However, communications from a LAN over a WAN to a server typically are relatively free of security restrictions. In addition, when a device that is part of a LAN initiates Internet protocol (“IP”) communications with a server across a WAN, a return path for communications from the server to the device is established. It may be very difficult, if not impossible, to configure a server to initiate communications with a device that resides inside a firewall. However, an intelligent device inside a firewall may be configured to initiate communications with a server outside the firewall with little effort. Moreover, once an intelligent device inside a firewall establishes communications with a server outside the firewall, a line of communication is established that the server can use to communicate back through the firewall to the intelligent device.

With the rapid reduction in cost, size, and energy consumption of the hardware and software necessary to support IP communications, it has become cost-effective to produce more types of network devices, also referred to herein as controllers, with the capability to communicate via IP. In addition it has become possible to add IP communication capabilities to existing network devices so that they can be polled, managed and maintained over a network. Network devices that include IP communications capabilities are referred to herein as intelligent network devices or intelligent controllers. With proper encryption and other security measures, these intelligent network devices can use the open Internet while communications remain private and secure.

Such intelligent network devices may use existing network infrastructure (e.g., a wired LAN) to establish a LAN of devices. The devices may be positioned anywhere with respect to one another as long as each device has access to the network infrastructure. Also, intelligent devices may be added or removed without reconfiguring the entire LAN. In another embodiment, if the device has wireless communication capabilities and is within range of, in one exemplary embodiment, a WiFi hotspot, the device could simply be turned on and immediately become part of a functioning LAN of devices.

A small, networked device combined with an Internet-based central server for centralized management, increases the advantages of that networked device. There is no local computer or control panel to house, run, and maintain. There are no local programs to install and run. Furthermore, upgrades to the software may be automatic. If desired, the network device configuration and any data generated by the device may be accessed at any time and from any web browser.

Situations for using such intelligent network devices include situations where central control and management of the network devices would be advantageous and situations where the network devices have access to existing Internet infrastructure. In situations where the devices have access to existing Internet infrastructure, all of the advantages of secure networking may be realized without the expense of building and maintaining a separate network infrastructure.

Specific applications that may utilize devices with the aforementioned capabilities include, but are not limited to, physical access control using networked lock controllers, video monitoring using IP-ready digital cameras, intercom systems, industrial control, utility metering, parking, gas, or electric meter management and control in a WiFi environment, and point-of-sale (POS) and other electronic payment systems.

In one embodiment, a system would generally be comprised of a network device or several network devices with the ability to communicate using the TCP/IP communications protocol, a network capable of supporting TCP/IP communications, a server, and for access to the system, any device that supports a web browser.

The system is not limited to TCP/IP and may work with other communications protocols. The network may be wired or wireless as long as the network supports the communications protocol that is being used. The server may be any computer that is capable of supporting the software applications underlying the system being deployed. The device for accessing the system may be any device that is capable of communicating with the server through one of its applications and via any communication link to the server. In specific embodiments, the device for accessing the system may include, but is not limited to, a web enabled device like a computer, a PDA, a cell phone, or a proprietary device dedicated to communicating with the system. Furthermore, the server may be configured to provide outbound communication in a variety of formats including, but not limited to, phone calls, pages, faxes, and e-mail messages.

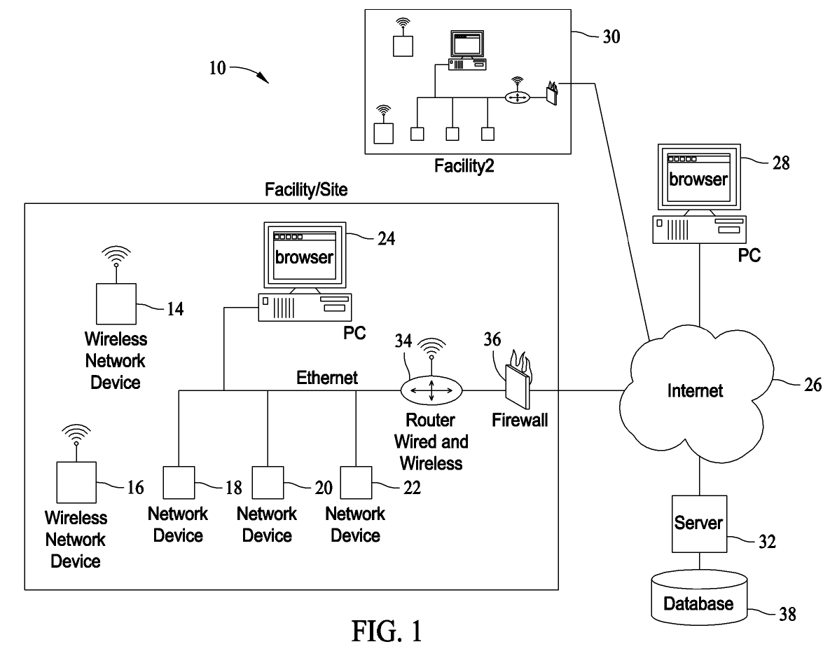

FIG. 1 is a schematic illustration of a network 10, including at least one intelligent network device. In an exemplary embodiment, network 10 includes intelligent network devices 14, 16, 18, 20, 22, remotely over the Internet 26 by a control device 28, which in one exemplary embodiment may be a personal computer (PC). FIG. 1 also includes a second network 30, to illustrate that a plurality of remotely located networks may be monitored and controlled using the systems and methods described herein.

Each individual intelligent network device 14, 16, 18, 20, 22, and 24 is capable of independent operation and is uniquely identified. In addition, each of the intelligent network devices 14, 16, 18, 20, 22, and 24 is IP enabled, network connected, and able to initiate connection to a known server 32. Each of the intelligent network devices 14, 16, 18, 20, 22, and 24 is communicatively coupled to a router 34. The intelligent devices each store a reference IP address (or multiple reference IP addresses in the case of a multiple server network) of the Internet server(s) with which each intelligent device is configured to initiate communications.

The router 34 may include, or be in communication with, a security device, such as a firewall 36. Communications between the intelligent network devices 14, 16, 18, 20, 22, and 24 and server 32 are initiated, in various exemplary embodiments, on a polling schedule (e.g., every hour), when there is some local activity (e.g., someone tries to use an intelligent device), or when a bootloader capable of checking for and requesting firmware upgrades initiates a connection.

The server 32 described herein supports the independent intelligent devices 14, 16, 18, 20, 22, and 24 and is capable of receiving and storing a unique identifier for each of the intelligent devices 14, 16, 18, 20, 22, and 24. The server 32 incorporates a highly scaled web server front-end that may be non-HTTP protocol based as well as a large scale transactional database 38 backend. For security reasons, all encryption keys are stored in an encrypted form and only exist in an unencrypted form immediately prior to use. In an exemplary embodiment, the encryption keys only exist in an unencrypted form in a computer memory (e.g., a random access memory (RAM)) immediately prior to use.

Communications between the intelligent devices 14, 16, 18, 20, 22, and 24 and the server 32 are encrypted and the server 32 and the intelligent devices 14, 16, 18, 20, 22, and 24 utilize shared key encryption. More specifically, each of the intelligent devices 14, 16, 18, 20, 22, and 24 has a unique identifier and a unique shared key and the server 32 maintains a database of device IDs for all of the intelligent devices 14, 16, 18, 20, 22, and 24 as well as each device's encryption key. Each device can only decrypt a message specifically intended for that device and only the server can decrypt a message sent from that device to the server. Even if the message or data is seen on the network or intercepted by another server it cannot be read.

The server 32 may host a web site that includes web pages for performing all of the functions related to managing the system. These functions may include, but are not limited to, configuring the network devices, configuring the system parameters, entering data related to the devices and users of the system, setting up automatic notifications that would be triggered by the system, events, including events detected and reported by the devices, producing reports based on data generated by the devices and the system, and reporting on the status of the devices and the system.

Access to the web site hosted by the server 32 is restricted to authorized users. In one embodiment, restricting access to the web site is done in a similar manner to web sites that provide private services such as online banking or online stock trading.

In an exemplary embodiment, the server 32 includes a simple computer running a database program, a web server, a mail server, and any other application specific to the overall purpose of the system. These applications could include applications for managing, analyzing, and archiving digital video, and applications for processing audio information including voice transmissions.

During operation, after one of the intelligent devices 14, 16, 18, 20, 22, and 24 identifies itself in clear text to the server 32, messages in both directions are encrypted using the shared key for the intelligent device that initiated communications. An encrypted portion of each message contains a message counter (e.g., a nonce) making each message unique and auditable.

In an exemplary embodiment, the intelligent devices 14, 16, 18, 20, 22, and 24 include software and/or hardware to support the aforementioned communications including either an 802.11x compliant (e.g., IEEE 802.11a, 802.11b, or 802.11g) antenna or an Ethernet compatible connector.

In another exemplary embodiment, it may be desirable for the intelligent devices 14, 16, 18, 20, 22, and 24 to continue to operate in spite of a local power failure. In such embodiments, a backup power supply is included so that the intelligent devices 14, 16, 18, 20, 22, and 24 may continue to operate until power is restored.

Additionally, in another exemplary embodiment, it may be desirable for the intelligent devices 14, 16, 18, 20, 22, and 24 to continue to function properly even when network communications are interrupted. In this exemplary embodiment, the intelligent devices 14, 16, 18, 20, 22, and 24 include sufficient processing power and memory so that they may work autonomously from the network for periods of network outages. In this embodiment, the intelligent devices 14, 16, 18, 20, 22, and 24 may work autonomously during either a period of a LAN outage or a WAN outage. In an embodiment where the network includes an access control system, the intelligent devices 14, 16, 18, 20, 22, and 24 may store permissions and tokens for people who are allowed access through the doors that the devices control. In an embodiment where the network includes a metering application, the devices 14, 16, 18, 20, 22, and 24 may include memory for storing hourly meter readings so that those readings may be saved and uploaded to the server 32 once network communications are reestablished.

Other aspects and capabilities of the intelligent devices 14, 16, 18, 20, 22, and 24 may be specific to the task for which each intelligent device is designed.

With respect to a communication protocol between the server 32 and the intelligent devices 14, 16, 18, 20, 22, and 24, the protocol may include multiple request-response exchanges. In operation, one of the intelligent devices, for example, intelligent device 14, first sends an unencrypted message to the server 32 to identify itself and to open a line of communication. Utilizing encryption, the intelligent device 14 then reports current activity, current status, previously unreported activity, and any other information predetermined to be pertinent by a user who configured the intelligent device 14. The server 32 then takes over control of the communication with the intelligent device 14 and issues, in an example embodiment, configuration changes and new operating rules. When the server 32 has completed the communication, the intelligent device 14 has the opportunity to transmit additional messages to the server 32 or close the connection between the two.

The connection between the server 32 and the intelligent devices is analogous to a PC's interaction with the world wide web (WWW). The local capabilities of the intelligent devices 14, 16, 18, 20, 22, and 24 reduce dependence on the server 32 by the network 10. The reduction in dependence on the server 32 enhances the fault tolerance of the network 10.

With respect to security, the unique shared keys of each of the plurality of intelligent devices 14, 16, 18, 20, 22, and 24 make it difficult to compromise a large number of the intelligent devices, except at the server 32. However, it is easiest to maintain the highest levels of security at the server 32. With the herein described configurations, compromising one message or one intelligent device does not compromise the entire network 10. In addition to the security provided by the independence of each of the intelligent devices 14, 16, 18, 20, 22, and 24, the server 32 and the intelligent devices 14, 16, 18, 20, 22, and 24 log all activities and any abnormalities are reported. Therefore, the entire system may be evaluated for consistency while the server 32 passively monitors the intelligent devices.

When the intelligent devices 14, 16, 18, 20, 22, and 24 are on a set polling schedule, the server 32 knows when a message is expected from each device. If a particular intelligent device does not report as expected, a notification may be generated by the server 32 and appropriate action taken to investigate and remedy the problem. While the server 32 would not have any information regarding the specific intelligent device until the device comes back online and reports to the server with data explaining the abnormality, the device may be equipped with back-up communications capabilities to further ensure security and fault tolerance. In one embodiment, back-up communications capabilities are provided via a cellular network.

In operation, a message sent between one of the devices 14, 16, 18, 20, 22, and 24 and the server 32 may consist of several parts including, but not limited to: a unique device identification, a data portion length, an encrypted flag indicating if the data portion of the message is encrypted, and a data portion.

The unique device identification may be a network media access control (MAC) address. All network interfaces have a unique MAC address that stays with the device, which makes MAC addresses a good device identifier. The encrypted flag indicating if the data portion of the message is encrypted is primarily used for a test mode. The data portion may include device commands, information for the server, as well as acknowledgements for messages received. An example intelligent device/server message exchange is provided below.

The interaction outlined above may be based on the server being provided with the configuration information that is needed for the installation of a particular device or set of devices. That configuration information may be provided by an owner/user of the system prior to installation through a browser interface to the server. Alternatively, the information may be provided in real time as the device is installed. The owner/user may, through a web browser, input information to the server that may in turn be used to configure the device.

For example, in a metering system, the owner/user may be required to input the address of the installation along with other information that was specific to the installation. That information would then be added to the server's database and appropriate configuration parameters would then be loaded into the device from the server.

An example protocol for communications between the intelligent devices and the server over TCP/IP is described below in more detail. Specifically, the intelligent devices 14, 16, 18, 20, 22, and 24 initiate connections with the server 32, which is listening on previously agreed upon ports. Once the connection is established, each device identifies itself in the first unencrypted HTTP-like header of each message. This header includes the message length and other non-application level information. The server 32 looks up the shared key for this device and for the remainder of the TCP/IP session all messages in both directions are encrypted/decrypted using this key. Each message contains a message counter (e.g., a nonce) that is unique to the device and server and ensures each message is unique and auditable.

The following is an example of a message exchanged between an intelligent device and a server:

| | Message |
|---|---|
| Intelligent | Opens connection |
| Device | |
| Intelligent | HEADER(<identifier><msg_len>)+ |
| Device | ENCRYPTED(<message 1>) |
| Server | HEADER(<msg_length>)+ENCRYPTED(<message 2>) |
| Intelligent | HEADER(<msg_length>)+ENCRYPTED(<message 3>) |
| Device | |
| Server | HEADER(<msg_length>)+ENCRYPTED(<message 4>) |
| Intelligent | Closes connection |
| Device | |

The series of messages exchanged between a connection opening and the connection closing is referred to as a session or a conversation. During a conversation, the intelligent device and the server exchange control of the conversation. The intelligent device initiates the connection to the server, which is also referred to above as the intelligent device opening the connection with the server. The intelligent device then transmits an encrypted message to the server (i.e., the intelligent device transmits information the device was preconfigured to send to the server). The server responds to the commands or information from the intelligent device with it own encrypted message(s). As shown in the above example message, each encrypted message is preceded by a header.

To exchange control of the conversation, when a transmission is completed, a hand-off message is sent. The hand-off message changes control of the conversation, either from the intelligent device to the server, or from the server to the intelligent device. In an example embodiment, when the intelligent device has completed transmitting an encrypted message to the server and receiving an encrypted response message from the server, a hand-off message is sent. The server may then send any additional commands to the intelligent device utilizing encrypted messages while the intelligent device responds. When the server is finished sending the additional command messages, it sends a hand-off message to the intelligent device. At that point, the intelligent device has the option to either close the connection or continue the conversation with the server.

In another example embodiment, when the intelligent device has completed transmitting an encrypted message to the server, a hand-off message is sent to the server, following which a response is sent to the intelligent device by the server. In other words, a hand-off message is sent before control of the communication may change.

Each individual message exchanged between the intelligent device and the server includes a protocol header. The header contains clear text information necessary to manage the message itself. The first message of a conversation includes the unique device identifier. The headers of subsequent messages also indicate the length of the data stream of that particular message. The header is separated from the corresponding data stream by two end-of-line characters (e g., “†n†n”).

Each individual message exchanged between the intelligent device and the server also includes a unique network device identifier. As stated above, a MAC address is a well-established and well-known unique identifier for all network-enabled devices. When the unique identifier is passed to the server, it is in clear ASCII text. This information is already available on the device's local network.

Each individual message exchanged between the intelligent device and the server also is encrypted. In an exemplary embodiment, messages are encrypted using an Advanced Encryption Standard (AES), also known as Rijndael. AES has become the United States Government's standard and is well known and suited for use with the present system. It can be specified in the header if the message is not encrypted using AES.

The encrypted part of the messages between the intelligent devices and the server contains all the information the device is preset to communicate to the server (e.g., activity, logs, and status), any instructions the server has for the device (e.g., reconfiguration, and schedules), and acknowledgements for all messages. The specific content and format of the messages will vary. To allow this, an XML subset will be used. XML is flexible and powerful. The elements are defined at the application level. Since these messages may become large, the messages may be compressed before encrypting.

The following is an exemplary message from the device to the server:

```
<message>
    <id>123</id>
    <activity>
        <type>entry</type>
        <userid>8745</userid>
        <time>1132215725</time>
        <picture length=234>(234 binary
        bytes)</picture>
    </activity>
</message>
```

The following is an exemplary server response:

```
<message>
    <id>2123</id>
    <ack>
        <id>123</id>
        <status>OK</status>
    </ack>
</message>
```

The “<status>” tag value may be a request for a resend of the message, a notification that the server is busy, or another type of message. The above is an example exchange between an intelligent device and the server where the intelligent device is reporting an entry with a timestamp and an image.

The following is an example of a message exchanged between an intelligent device and a server:

| | Message |
|---|---|
| Intelligent | Opens connection |
| Device | |
| Intelligent | Device-Id: 00C0F05615DC |
| Device | Content-Length: 2545 |
| | ENCRYPTED(COMPRESSED( |
| | <message> |
| | <id>123</id> |
| | <activity> |
| | <type>entry</type> |
| | <userid>8745</userid> |
| | <time>1132215725</time> |
| | <picture length=2340>(2340 binary |
| | bytes)</picture> |
| | </activity> |
| | </message> |
| | )) |
| Server | Content-Length: 358 |
| | ENCRYPTED(COMPRESSED( |
| | <message> |
| | <id>2123</id> |
| | <ack> |
| | <id>123</id> |
| | <status>OK</status> |
| | </ack> |
| | <handoff/> |
| | </message> |
| | )) |
| Intelligent | Closes connection |
| Device | |

The message ID is a sequential, increasing number value. It wraps around at 32767 back to 0. Gaps in the sequence are recorded and audited in order to ensure that sent messages have been received.

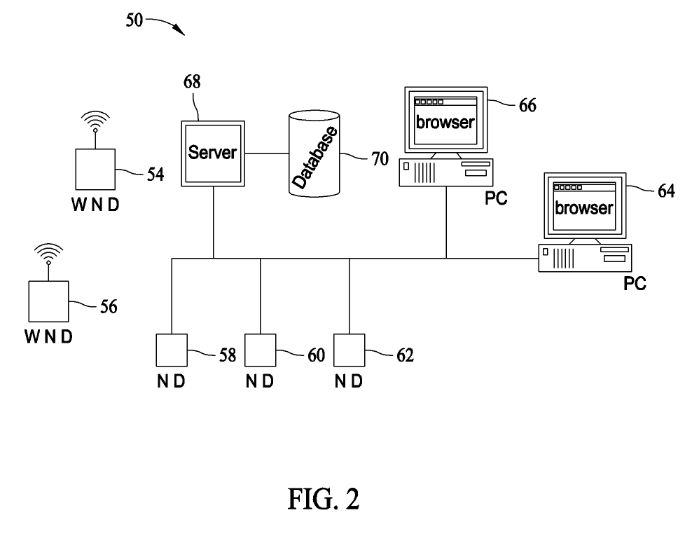

FIG. 2 is a schematic illustration of a network 40 that includes intelligent network devices 54, 56, 58, 60, 62, and 64 networked in accordance with another embodiment of the present invention. In the exemplary embodiment of FIG. 2, network 40 is managed locally through a local area network (LAN). Being a web application, a server may be deployed on the open Internet (as shown in FIG. 1) or on a LAN local to the devices. If an institution wanted to manage its own server, the server may be deployed on the LAN or in the institution's Internet domain. In the exemplary embodiment of FIG. 2, network 40 is managed locally through a local area network by a control device 66, which in one exemplary embodiment may be a PC. As in the embodiment of FIG. 1, network 40 includes a server 68 that may incorporate a highly scaled web server front-end, which may be non-HTTP protocol based, as well as a large scale transactional database 70 backend.

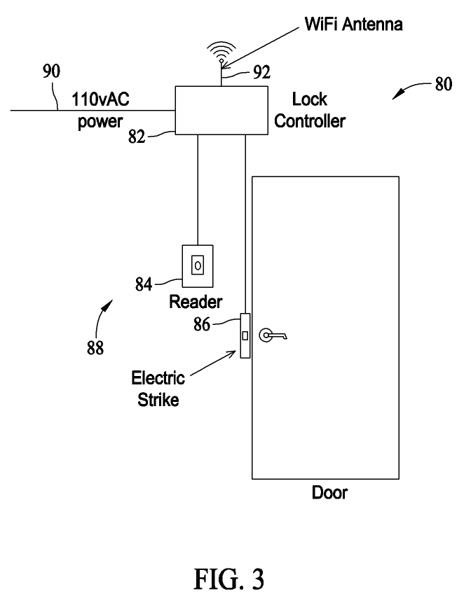

FIG. 3 is a schematic illustration of an exemplary embodiment of a particular application of the networks of FIG. 1 and FIG. 2. More specifically, FIG. 3 is a schematic of an access control system 80 that may control access to a door and/or monitor access to a door. The access control system 80 includes an intelligent network device, as described above, which in this embodiment is a lock controller 82. The lock controller 82 is in communication with a token authentication device (herein referred to as a reader) 84 and an access control device (e.g., an electric strike 86). Collectively, lock controller 82, reader 84, and electric strike 86 are referred to as a reader/controller 88. Reader 84 may be one of several devices alone or in conjunction with others, including but not limited to, a numeric keypad, a card reader, a radio frequency identification (RFID) reader, a fingerprint reader, an iris scanners, a voice recognition device, and a smart card reader. The electric strike 86, or other access control device on a door or door jamb, allows the reader/controller 88 to control access via that door, and in some embodiments, monitor whether the door is opened or closed.

FIG. 3 illustrates a first exemplary configuration for providing power and network connectivity to reader/controller 88. The reader/controller 88 is powered by either a line current or a battery 90 Lock controller 82 distributes power to both the reader 84 and the electric strike 86 Lock controller 82 also may provide data to, and receive data from, each of the reader 84 and the electric strike 86 The reader/controller 88 includes, in an exemplary embodiment, a WiFi antenna 92 With the WiFi antenna 92, the reader/controller 88 is capable of wireless communication with a server and a control device via the TCP/IP communication protocol over a wireless network.

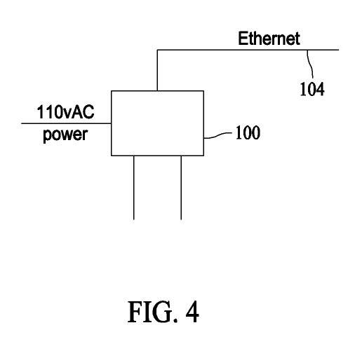

FIG. 4 illustrates a second exemplary configuration for providing power and network connectivity to a reader/controller 100. As with the reader/controller 88, the reader/controller 100 is powered by either a line current or a battery 102. However, reader/controller 100 includes an Ethernet connection and is configured to communicate with a network over an Ethernet cable 104.

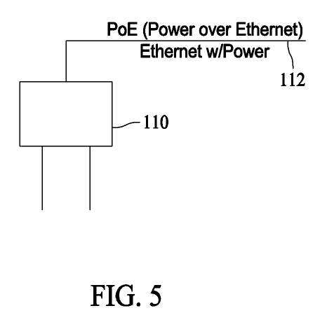

FIG. 5 illustrates a third exemplary configuration for providing power and network connectivity to a reader/controller 110. Reader/controller 110 includes an Ethernet connection 112 Ethernet connection 112 not only provides network connectivity to reader/controller 110 but also supplies power to reader/controller 110 (i.e., Power Over Ethernet).

Any combination of wireless connectivity, Ethernet connectivity, line current, battery power, and Power Over Ethernet may accomplish networking access control as described herein.

When a reader/controller, such as reader controllers 88, 100, and 112, is installed at each door and provided with power, it will attempt to send a message to the central server 32 over the Internet or a local area network, and register with the central server 32. Initial ownership of each device 88, 100, and 112 will be granted to the purchaser of the device. Once all of the reader/controllers are installed, or even as the reader/controllers are being installed, the owner/user will name and describe the devices and configure them using a web interface to the central server 32.

In an access control system, a variety of types of information may be stored in association with each reader/controller including but not limited to: the location, the building, the floor or level, the department or group to which the access point belongs, the dates and times for which access should be allowed, who to notify in the case of a breach or device failure, by what means to provide notification, and how often to report to the central server for instructions when there is no other activity.

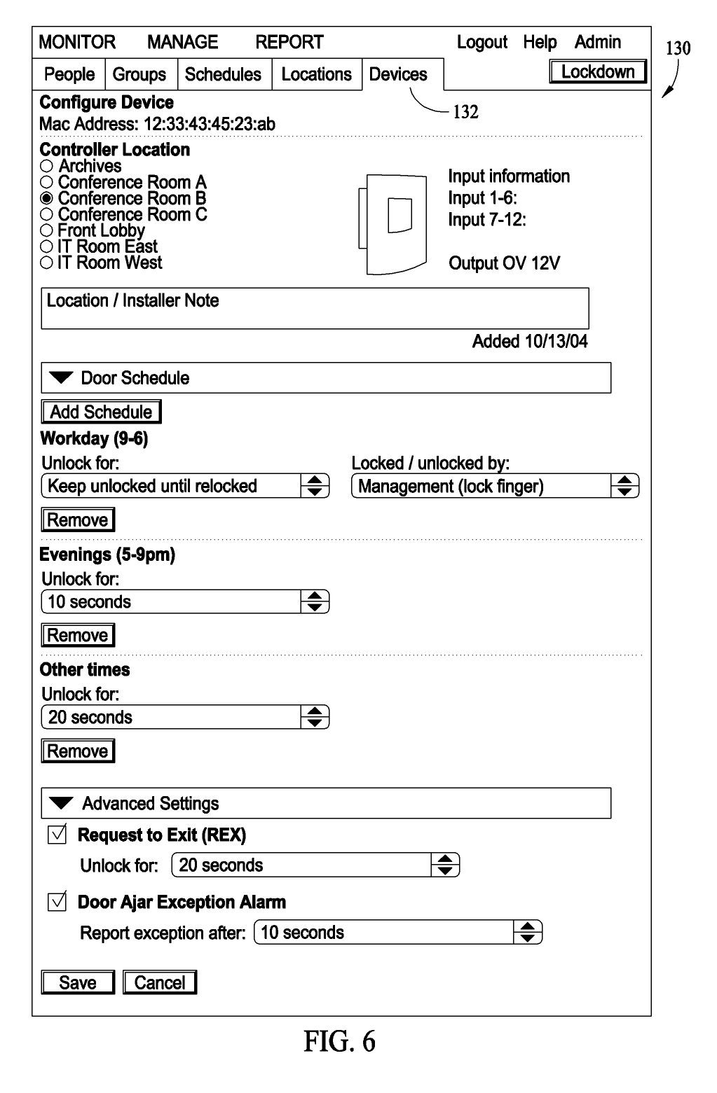

FIG. 6 is an exemplary screen-shot of an embodiment of a web page 130 used to configure an access control system. In the embodiment of FIG. 6, a “Devices” tab 132 has been selected. The web page 130 displayed upon selecting the “Devices” tab 132 allows a user to configure the reader/controllers in a physical access control application. The web page 130 includes menus that allow a user to input a schedule of when a particular door should be locked and unlocked, and who is given permission to unlock the door when locked.

Access credentials, door schedules and any other information the intelligent device needs to operate autonomously without consulting the server, is passed from the server to the appropriate device in the above described message exchange. The server queries and analyzes the current configuration of the device and makes required adjustments to the configuration of the device such that the configuration of the device matches the configuration input into the server by a user. In one embodiment, once all of the reader/controllers have been configured, information about the users may be added to the system database.

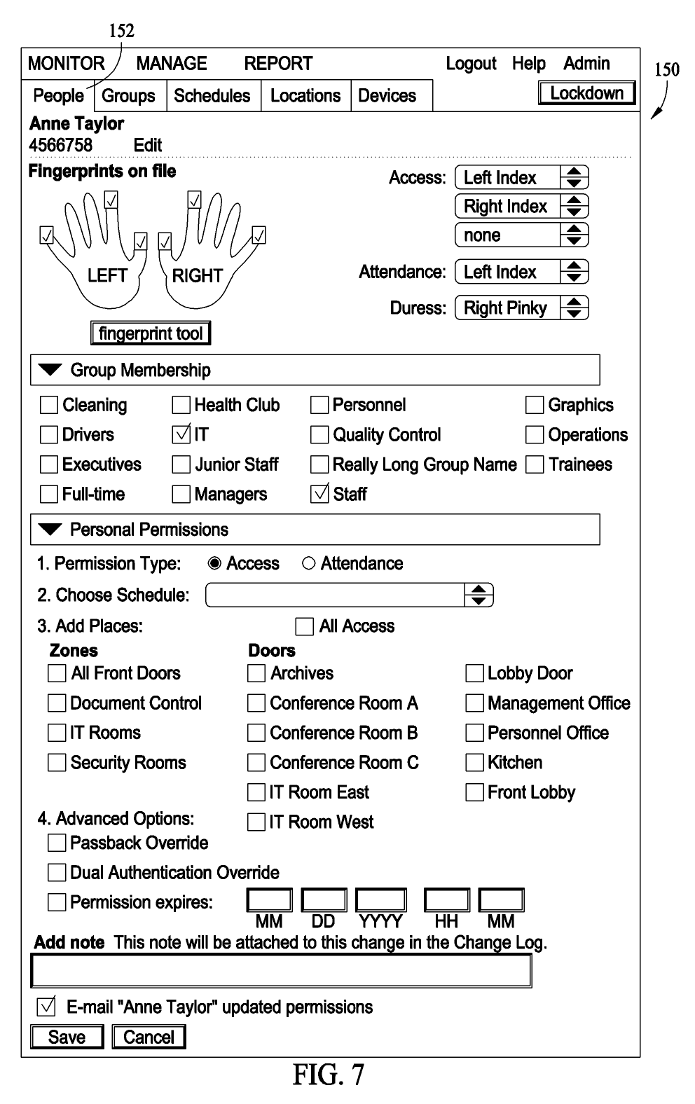

FIG. 7 is an exemplary screen-shot of one embodiment of a web page 150 used to configure an access control system. In the embodiment of FIG. 7, a “People” tab 152 has been selected. The web page 150 displayed upon selecting the “People” tab 152 allows a user to select which doors in a physical access control system a particular person is allowed to unlock. User information is introduced to the system through a web interface to the central server. Much of this information may already reside in an employee database and the information may be added en masse to the access control system database. In any case, additional information may be added to make the system fully functional. Beyond basic information like name, title, department, photograph, and contact information, additional information, for example, fingerprint data, may be stored.

In the example of a corporate installation, each employee may be assigned to one or more groups within the corporation. For example, a Vice President of Marketing may be assigned to the marketing group, the senior management group, and the corporate headquarters group. The establishment of groups, and the assignment of individuals to groups, may be accomplished through a webpage interface to the server.

Once the users have been entered into the system and have been grouped, permissions for the users and the groups are established. In the example above, the Vice President of Marketing may be granted permission for his own office door. Through his groupings he may be granted access respectively to the marketing department's conference room, the executive restroom, and the front door of corporate headquarters.

In another example, members of the custodial staff may be given permission to access all doors in a group entitled the “office doors” group, but only between the hours of 7 pm and 11 pm on Tuesdays and Fridays.

In addition to the permissions associated with access control, a web page may be provided for assigning permissions for the system itself. Through this page, users may be given permission for performing various system functions. For example, a person in the Human Resources group may be given permission to enter user data while another person in the Security group may be given permission to enroll an employee and issue an associated card or code. Managers may be given permission to generate reports on the comings and goings of the employees who report to them.

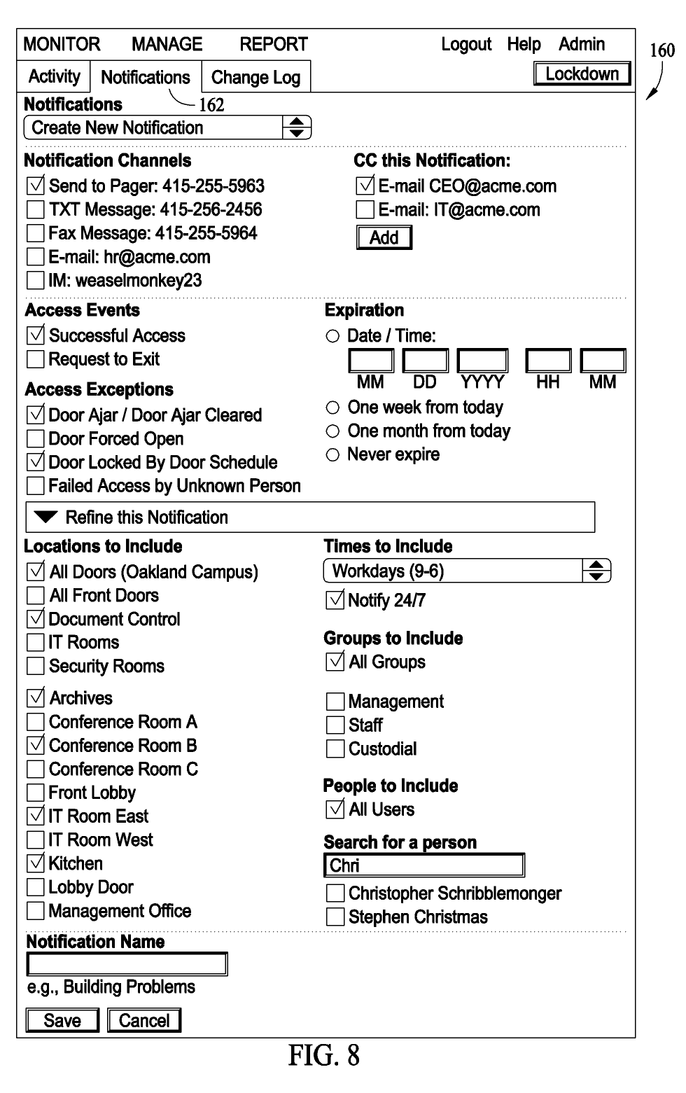

FIG. 8 is an exemplary screen-shot of an embodiment of a web page 160 used to configure an access control system. In the embodiment of FIG. 8, a “Notifications” tab 162 has been selected. Each reader/controller generates data about events that occur at its associated access point. In addition, the system itself creates and stores data relating to its own functions. The web page 160 displayed upon selecting the “Notifications” tab 162 allows a user to configure the access control system to provide particular people with automatic notifications based on specific system events via one or more communication methods.

The types of events that may trigger a notification may include, but are not limited to, the entry of a particular individual through a certain door, multiple failed access attempts at a door, a power failure at an access point, a door left open, and the enrollment of a new employee. The notification may be made to any person or group of people whose contact information is stored in the system. The method of notification may be in one or more of many forms including, but not limited to, an e-mail, a page, a phone call, a fax, and a text message.

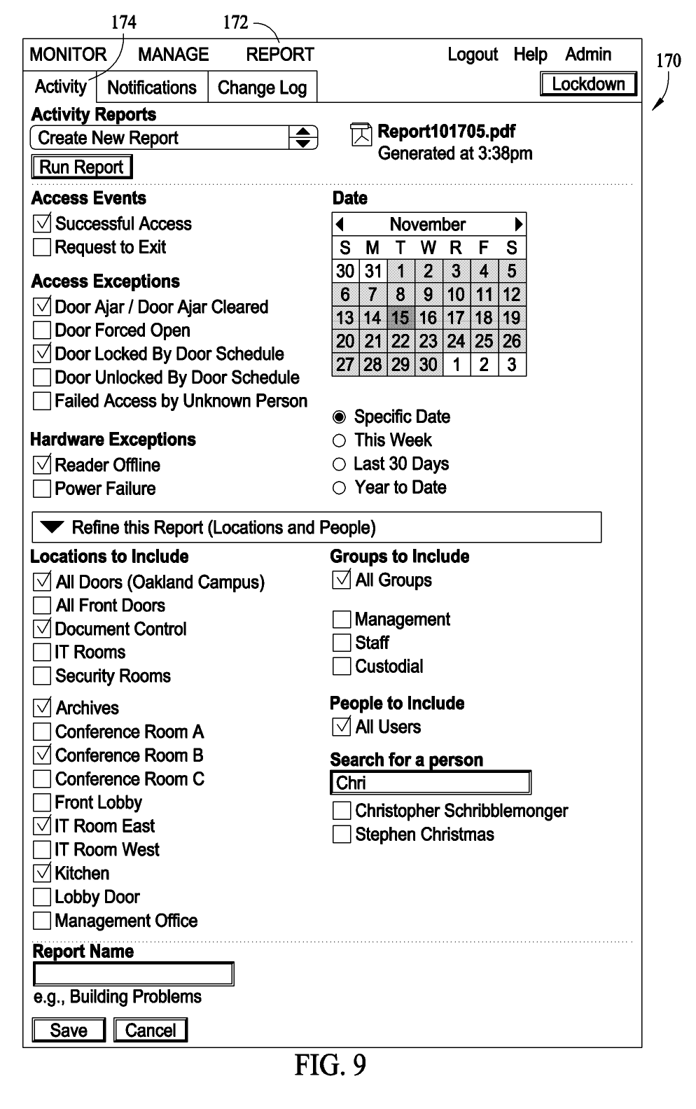

FIG. 9 is an exemplary screen-shot of an embodiment of a web page 170 used to configure an access control system. In the embodiment of FIG. 9, a “Report” tab 172 and an “Activity” tab 174 have been selected. Information collected from the devices may be stored in a database on the central server and made available to users in a variety of reports through the central server web interface. Users with the proper permissions are allowed to access and generate reports based on this data. An interface is provided so that one may create a report, for example, that showed a list of all the people that accessed a particular door on a particular hour of a certain day, or a list of all of the new users that had been enrolled in the previous month.

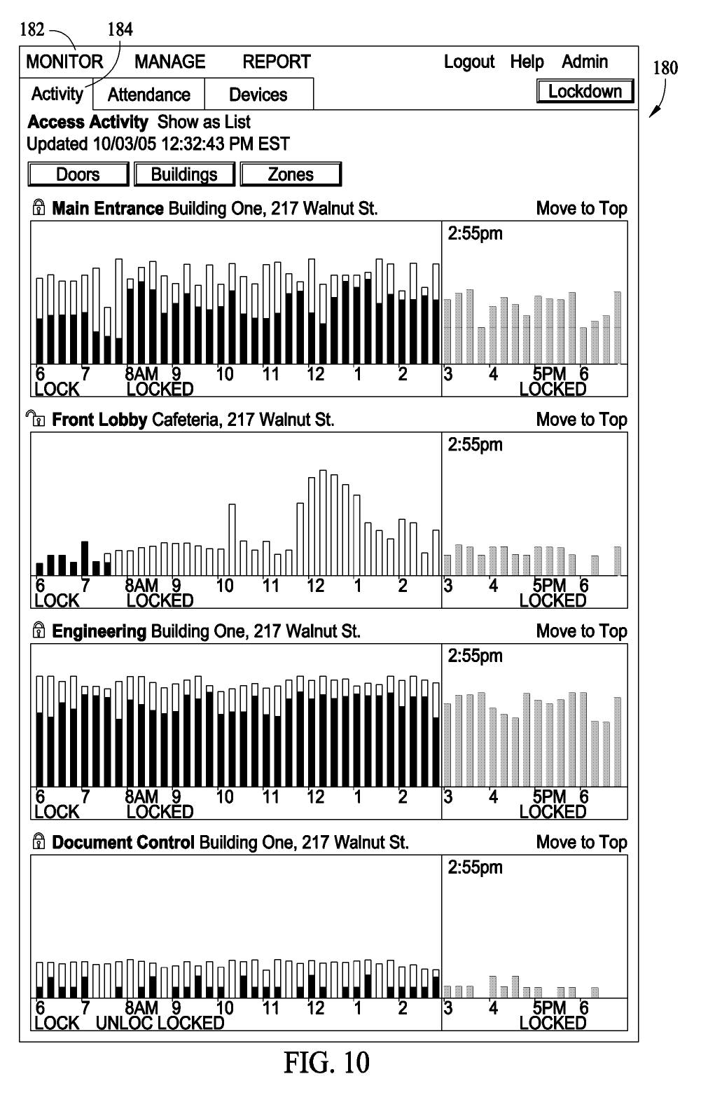

FIG. 10 is an exemplary screen-shot of an embodiment of a web page 180 used to monitor an access control system. In the embodiment of FIG. 10, a “Monitor” tab 182 and an “Activity” tab 184 have been selected. Information collected from the devices may be displayed as it is received by the server, allowing for real-time monitoring of the system. In an example embodiment, a browser window 180 is displayed that shows access activity at each particular door, along with alerts notifying the person monitoring the system of exceptional events that occur as they occur, allowing immediate human intervention as required.

While the invention has been described in terms of various specific embodiments, those skilled in the art will recognize that the invention can be practiced with modification within the spirit and scope of the present invention.

What is claimed is:

1. A controller for providing autonomous control of an electro-mechanical device, said controller comprising:
a processing device;
a memory associated with said processing device;
at least one input/output (I/O) interface associated with said processing device;
said controller configured to operate at least one electromechanical device connected thereto and to maintain proper operation of the controller and the electromechanical device by reporting activity to a server and requesting configuration updates from the server.

2. A controller according to claim 1, wherein said controller is located inside of a firewall and the server is located outside of the firewall, said controller configured to initiate communications with the server through the firewall.

3. A controller according to claim 2, wherein said controller is configured to initiate communications with the server by initiating a connection with the server, identifying itself to the server, identifying the message length, receiving an encrypted message from the server, responding with an encrypted message, and closing the connection.

4. A controller according to claim 1, wherein said controller is configured to operate autonomously from the server during periods of normal network operation and during periods when the network is not operational.

5. A controller according to claim 1, wherein said controller is configured to communicatively couple to the server over the Internet.

6. A controller according to claim 1, wherein said controller comprises at least one of a token authentication device and a lock controller within an access control system.

7. A controller according to claim 6, wherein said token authentication device comprises at least one of a numeric keypad, a card reader, a radio frequency identification reader, a fingerprint reader, an iris scanner, a voice recognition device, and a smart card.

8. A controller according to claim 6, wherein said lock controller comprises an access control device on at least one of a door and a door jamb, said access control device configured to receive information from said token authentication device.

9. A controller according to claim 1, wherein said controller comprises a monitoring device within a metering application.

10. A controller according to claim 1, wherein said controller comprises at least one of an IP-ready digital camera, an intercom system, an industrial control system, a meter management and control system, and an electronic payment system.

11. A controller according to claim 10, wherein said meter management and control system comprises at least one of a utility meter, a parking meter, a gas meter, and an electric meter.

12. A system for controlling an electromechanical device, said system comprising:
at least one server, positioned outside of at least one security feature; and
at least one controller, positioned inside at least one security feature and coupled to an electromechanical device, said at least one controller configured to initiate communications with said at least one server over a network, said at least one controller comprising a processing device and a memory associated with said processing device, said controller configured to operate the electromechanical device independent of said server.

13. A system according to claim 12, wherein said at least one security feature comprises a firewall configured to prevent unauthorized access to said at least one controller.

14. A system according to claim 12, wherein said at least one security feature comprises a network router configured to dynamically assign IP addresses to said at least one controller.

15. A system according to claim 14, wherein said network router is configured to use a Dynamic Host Configuration Protocol in order to dynamically assign IP addresses to said at least one controller.

16. A system according to claim 12, wherein said at least one controller is independent from the other said controllers, and each of said at least one controllers is configured to operate autonomously from said network, including during a period of network outage.

17. A system according to claim 12, wherein said at least one controller is communicatively coupled to said server over the Internet.

18. A system according to claim 12, wherein said at least one controller is communicatively coupled to said server over a local area network.

19. A method of configuring a controller to provide autonomous control of an electromechanical device, said method comprising:
configuring the controller to perform at least one of a monitoring and a control application, the application comprising an electro-mechanical device;
configuring the controller to initiate communications with a server; and
configuring the controller to report activity and request updated configurations from the server.

20. A method according to claim 19, wherein configuring the controller to initiate communications with the server comprises configuring the controller to initiate a connection with the server and transmit information to the server.

21. A method according to claim 19, further comprising configuring the controller to transmit encrypted information, the information comprising at least one of a current activity, a current status, and a previously unreported activity.

22. A method according to claim 19, further comprising configuring the server to respond to the communications from the controller with an encrypted message.

23. A method according to claim 22, wherein the encrypted message comprises at least one of a configuration change and a new controller operating rule.

24. A method according to claim 19, wherein configuring the controller to initiate communications with the server comprises configuring the controller to operate autonomously from other controllers.

25. A method according to claim 19, wherein configuring the controller to initiate communications with the server comprises providing a polling schedule to the controller to initiate communications with the server at predetermined intervals.

26. A method according to claim 19, wherein configuring the controller to initiate communications with the server comprises configuring the controller to initiate communications with the server upon local activity occurring at the controller.

27. A method according to claim 19, wherein configuring the controller to initiate communications with the server comprises configuring the controller to initiate communications with the server upon the instructions of a bootloader.
